(19) United States
(12) Patent Application Publication
(10) Pub. No.: US 2020/0159254 A1
(43) Pub. Date: May 21, 2020

(54) METHOD FOR PROCESSING OUT-OF-SYNCHRONIZATION OF UNMANNED AERIAL VEHICLE, UNMANNED AERIAL VEHICLE, AND UNMANNED AERIAL VEHICLE SYSTEM

(71) Applicant: SZ DJI TECHNOLOGY CO., LTD., Shenzhen (CN)

(72) Inventors: Xiongbin RAO, Shenzhen (CN); Ning MA, Shenzhen (CN); Naibo WANG, Shenzhen (CN)

(21) Appl. No.: 16/740,830

(22) Filed: Jan. 13, 2020

Related U.S. Application Data
(63) Continuation of application No. PCT/CN2017/095205, filed on Jul. 31, 2017.

(51) Int. Cl. G05D 1/10; G01S 19/43; B64C 39/02

(52) U.S. Cl. CPC G05D 1/1064; G01S 19/43; B64C 2201/027; B64C 2201/143; B64C 39/024

(57) ABSTRACT

An out-of-synchronization processing method implemented by a first unmanned aerial vehicle (UAV) includes determining whether the first UAV is out of synchronization, obtaining base positioning information of a base station broadcasted by a second UAV in response to confirming that the first UAV is out of synchronization, and determining UAV positioning information of the first UAV based on the base positioning information. The first UAV and the second UAV belong to a UAV system including the base station and at least two UAVs.

### CROSS-REFERENCE TO RELATED APPLICATION

This application is a continuation of International Application No. PCT/CN2017/095205, filed on Jul. 31, 2017, the entire content of which is incorporated herein by reference.

### TECHNICAL FIELD

The present disclosure relates to the technical field of unmanned aerial vehicle (UAV) technology and, more particularly, to a method for processing out-of-synchronization of a UAV, a UAV and a UAV system.

### BACKGROUND

With the advancement of the UAV technology, the UAVs are widely used in more and more applications. In certain application scenes, a networking mode of the UAVs includes collaboration of a plurality of networked UAVs. For example, when the UAVs are used in an agricultural application, one control console controls multiple networked UAVs to improve operating efficiency.

In a multi-UAV collaborative networking mode, when a UAV is out of synchronization, the UAV is unable to obtain positioning information of a base station and high precision positioning information of the UAV, causing the UAV to deviate from a pre-set flight route.

### SUMMARY

In accordance with the disclosure, there is provided an out-of-synchronization processing method implemented by a first unmanned aerial vehicle (UAV) including determining whether the first UAV is out of synchronization, obtaining base positioning information of a base station broadcasted by a second UAV in response to confirming that the first UAV is out of synchronization, and determining UAV positioning information of the first UAV based on the base positioning information. The first UAV and the second UAV belong to a UAV system including the base station and at least two UAVs.

Also in accordance with the disclosure, there is provided a first unmanned aerial vehicle (UAV) including a processor and a computer-readable storage medium storing instructions that, when executed by the processor, cause the processor to determine whether the first UAV is out of synchronization, obtain base positioning information of a base station broadcasted by a second UAV in response to confirming that the first UAV is out of synchronization, and determine UAV positioning information of the first UAV based on the base positioning information. The first UAV and the second UAV belong to a UAV system including the base station and at least two UAVs.

Also in accordance with the disclosure, there is provided an unmanned aerial vehicle (UAV) system including, a base station, a first UAV, and a second UAV. The first UAV is configured to determine whether the first UAV is out of synchronization, obtain base positioning information of a base station broadcasted by a second UAV in response to confirming that the first UAV is out of synchronization, and determine UAV positioning information of the first UAV based on the base positioning information.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a system architectural diagram of a UAV system according to an example embodiment of the present disclosure.

FIG. 2 is a flowchart of a procedure for determining a UAV flight route in the existing technology.

FIG. 3 is a flowchart of a method for processing out-of-synchronization of a UAV according to an example embodiment of the present disclosure.

FIG. 4 is a schematic diagram of sending subframes in the method for processing out-of-synchronization of the UAV according to an example embodiment of the present disclosure.

FIG. 5 is a schematic diagram of an RTK subframe in the method for processing out-of-synchronization of the UAV according to an example embodiment of the present disclosure.

FIG. 6 is a flowchart of a method for processing out-of-synchronization of a UAV according to another example embodiment of the present disclosure.

FIG. 7 is a flowchart of a method for processing out-of-synchronization of a UAV according to another example embodiment of the present disclosure.

FIG. 8 is a structural block diagram of a first UAV according to an example embodiment of the present disclosure.

FIG. 9 is a structural block diagram of a first UAV according to another example embodiment of the present disclosure.

FIG. 10 is a structural block diagram of a first UAV according to another example embodiment of the present disclosure.

FIG. 11 is a structural block diagram of a first UAV according to another example embodiment of the present disclosure.

FIG. 12 is a structural block diagram of a first UAV according to another example embodiment of the present disclosure.

FIG. 13 is a structural block diagram of a first UAV according to another example embodiment of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

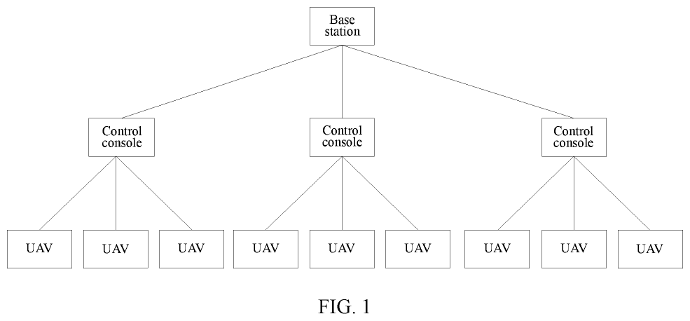

FIG. 1 is a system architectural diagram of an unmanned aerial vehicle (UAV) system according to an example embodiment of the present disclosure. A method for processing out-of-synchronization of a UAV can be applied to the UAV system. As shown in FIG. 1, the UAV system includes a base station, at least one control console, and at least two UAVs. The base station communicates with each control console through a bidirectional communication link. The base station controls multiple control consoles. Each control console controls multiple UAVs and can control each of the multiple UAVs through a bi-directional communication link.

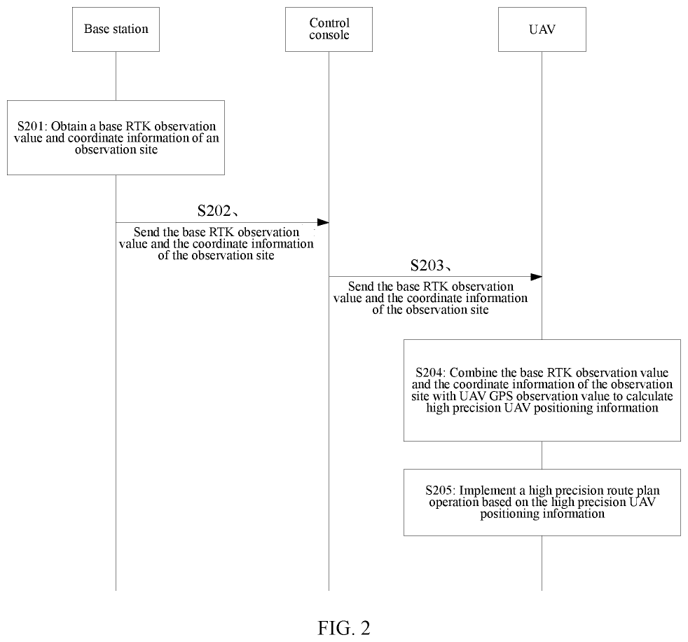

FIG. 2 is a flowchart of an example procedure for determining a UAV flight route. As shown in FIG. 2, the procedure includes the following.

At S201, a base station obtains a real time kinetics (RTK) observation value of the base station itself (also referred to as a “base RTK observation value”) and coordinate information of an observation site.

At S202, the base station sends the base RTK observation value and the coordinate information of the observation site to a control console via a wireless link from the base station to the control console.

At S203, the control console forwards the base RTK observation value and the coordinate information of the observation site to a UAV.

At S204, the UAV combines the base RTK observation value and the coordinate information of the observation site received from the control console with a global positioning system (GPS) observation value of the UAV itself (also referred to as a “UAV GPS observation value”) to calculate high precision positioning information of the UAV itself (positioning information of the UAV itself is also referred to as “UAV positioning information”).

At S205, the UAV implements a high precision route plan operation based on the high precision UAV positioning information.

In the above procedure, the UAV needs to determine the high precision UAV positioning information based on the combination of the base RTK observation value and the coordinate information of the observation site and the GPS observation value thereof, thereby implementing the high precision route plan operation. During operation, the UAV may be out-of-synchronization due to certain causes. For example, when the UAV gradually flies away from the control console, or when the communication link between the UAV and the control console is blocked degrading communication signal, the out-of-synchronization may occur. That is, the UAV is unable to communicate normally with the corresponding control console. In this case, the UAV is unable to obtain the base RTK observation value and the coordinate information of the observation site from the control console, and is unable to determine the high precision UAV positioning information. In the UAV system shown in FIG. 1, the base station communicates with multiple control consoles. Each control console in turn controls multiple UAVs. That is, the UAV system is a multi-UAV collaborative networking system. In this system, when a certain UAV is out of synchronization and is attempting to re-synchronize with its parent node (i.e., the control console controlling the UAV) by flying toward a home base, because the UAV is unable to determine the high precision UAV positioning information, the UAV may deviate from a pre-set flight route and to collide with other UAVs in operation.

To solve the above problem, the present disclosure provides a method for processing out-of-synchronization of the UAV. When the UAV is out of synchronization, the UAV is still able to obtain the base RTK observation value and the coordinate information of the observation site, thereby ensuring that the UAV is able to obtain the high precision UAV positioning information in case of out-of-synchronization.

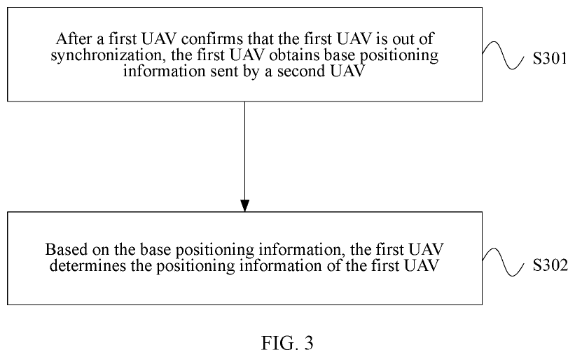

FIG. 3 is a flowchart of a method for processing out-of-synchronization of a UAV according to an example embodiment of the present disclosure. As shown in FIG. 3, the method includes the following.

At S301, after a first UAV confirms that the first UAV is out of synchronization, the first UAV obtains positioning information of a base station (also referred to as “base positioning information”) sent by a second UAV.

The first UAV can be any one of the UAVs in the UAV system. The second UAV can be any one of the UAVs in the UAV system other than the first UAV.

The positioning information of the base station is broadcasted by the second UAV.

In some embodiments, the base station controls the control consoles to broadcast the positioning information of the base station to the UAVs. After obtaining the positioning information of the base station, each UAV broadcasts the positioning information of the base station to surrounding UAVs according to a certain rule. For example, each UAV broadcasts at a certain time interval.

If the first UAV becomes out of synchronization, the first UAV obtains the positioning information of the base station from information broadcasted by a certain second UAV in the surrounding.

At S302, based on the positioning information of the base station, the first UAV determines the positioning information of the first UAV.

Specifically, after the first UAV obtains the positioning information of the base station from the information broadcasted by the surrounding second UAV, the first UAV determines the high precision UAV positioning information of the first UAV by combining the positioning information of the base station and the UAV GPS observation value of the first UAV.

Based on the high precision UAV positioning information, the first UAV precisely determines a return route and flies to the home base according to the return route to attempt to re-synchronize with its parent node. In some embodiments, the first UAV precisely determines a flight route of the first UAV to ensure that the first UAV will not collide with any other surrounding UAVs when the first UAV flies to the home base or according to the flight route. Further, based on the high precision UAV positioning information, the first UAV may perform its own work task, thereby ensuring normal completion of the work task.

In some embodiments, in case of out-of-synchronization, the first UAV obtains the positioning information of the base station from the information broadcasted by the second UAV, and determines the high precision UAV positioning information based on the obtained positioning information of the base station. As such, the first UAV can still determine the high precision UAV positioning information in case of out-of-synchronization and determines a correct return route or flight route, thereby avoiding collision with other UAVs due to deviation from the pre-set flight route.

In some embodiments, the first UAV obtains the positioning information of the base station from the information broadcasted by the second UAV. The positioning information of the base station includes the base RTK observation value and the coordinate information of the observation site.

Correspondingly, S301 includes, after the first UAV confirms that the first UAV is out of synchronization, the first UAV obtains the base RTK observation value and the coordinate information of the observation site from an RTK subframe sent by the second UAV.

After receiving the base RTK observation value and the coordinate information of the observation site from the parent node (i.e., the control console controlling certain UAVs), each second UAV that normally communicates with the parent node periodically broadcasts the base RTK observation value and the coordinate information of the observation site.

In some embodiments, the second UAV sends the base RTK observation value and the coordinate information of the observation site through the RTK subframe. For example, the second UAV periodically sends the RTK subframe at a pre-set position. The pre-set position is determined by a position of the second UAV in the UAV system, which is described in detail below with reference to drawings.

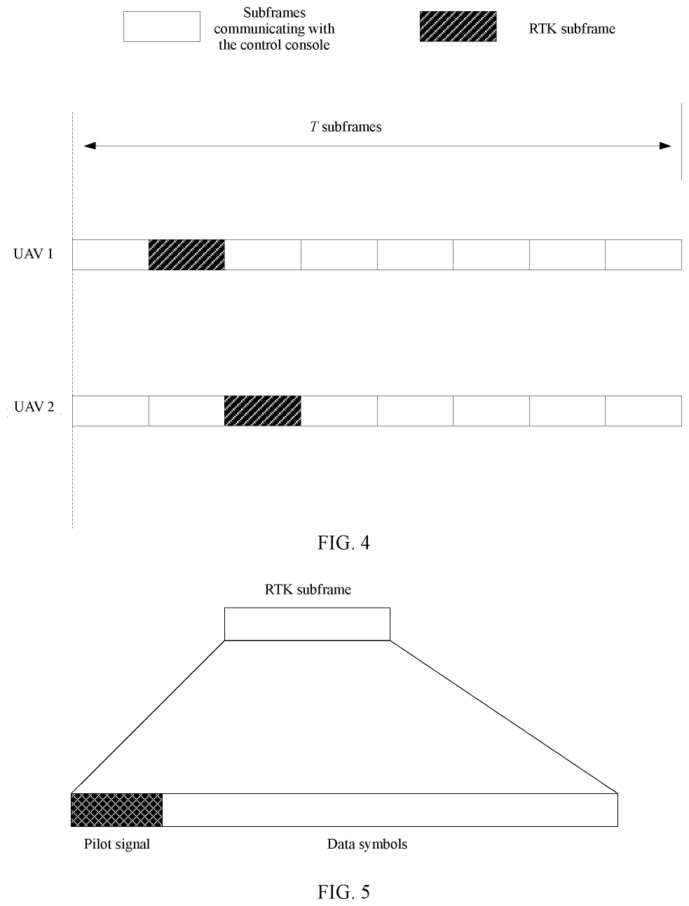

FIG. 4 is a schematic diagram of sending subframes in the method for processing out-of-synchronization of the UAV according to an example embodiment of the present disclosure. As shown in FIG. 4, both UAV 1 and UAV 2 are UAVs in the UAV system. In one embodiment, UAV 1 and UAV 2 are considered as the second UAVs. For example, at UAV 1, in every T subframes (T being a positive integer larger than 1), T−1 subframes are configured for communication with the control console, the remaining 1 subframe is configured for broadcasting the base RTK observation value and the coordinate information of the observation site. T satisfies the following equation:

T≥N*M, (1)

where N is a positive integer denoting a maximum number of control consoles supported by the UAV system, and Mis a positive integer denoting a maximum number of UAVs supported by each control console.

By satisfying the above equation, T ensures that every T subframes support sending the RTK subframe of all UAVs in the UAV system without conflict.

Further, referring to FIG. 4, UAV 1 and UAV 2 send the respective RTK subframes at different positions. The position at which each UAV sends the RTK subframe is determined by the position of the UAV in the UAV system to avoid the collision when the different UAVs send the RTK subframes at the same time. Specifically, assuming that the control console (i.e., the parent node) corresponding to the UAV is the n-th control console in the UAV system and the UAV is the k-th UAV controlled by the control console, the position L in which the UAV sends the RTK subframe can be calculated by the following equation:

L=n*M+k, (2)

that is, the RTK subframe is the L-th subframe in the T subframes sent by the UAV. M is the maximum number of the UAVs supported by each control console. n, k, and L are positive integers.

In some embodiments, due to different orders for different UAVs, each UAV has a different L derived by the above equation (2). As such, it is ensured that each UAV sends the RTK subframe as a different position in every T subframes to avoid the collision when the different UAVs send the RTK subframes at the same time.

Further, FIG. 5 is a schematic diagram of an RTK subframe in the method for processing out-of-synchronization of the UAV according to an example embodiment of the present disclosure. As shown in FIG. 5, the RTK subframe includes two segments of a pilot signal and data symbols. The pilot signal is introduced in the RTK subframe ensures that the UAV that loses the synchronization is able to re-synchronize with the RTK subframe. The data symbols of the RTK subframe are configured to carry the base RTK observation value and the coordinate information of the observation site.

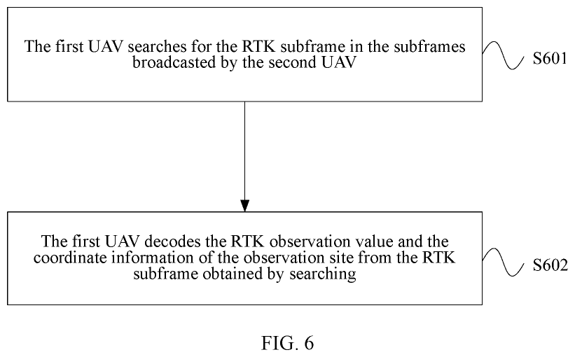

The present disclosure provides a method in which the UAV obtains the base RTK observation value and the coordinate information of the observation site from the RTK subframe. FIG. 6 is a flowchart of a method for processing out-of-synchronization of a UAV according to another example embodiment of the present disclosure. As shown in FIG. 6, the method in which the first UAV obtains the base RTK observation value and the coordinate information of the observation site from the RTK subframe includes the following.

At S601, the first UAV searches for the RTK subframe in the subframes broadcasted by the second UAV.

At S602, the first UAV decodes the RTK observation value and the coordinate information of the observation site from the RTK subframe obtained by searching.

In some embodiments, as shown in FIG. 4, the UAV broadcasts one RTK subframe in every T subframes. If the first UAV is out of synchronization, the first UAV actively searches the RTK subframe in the information broadcasted by the surrounding UAVs. When the RTK subframe is obtained, the first UAV decodes the RTK observation value and the coordinate information of the observation site from the obtained RTK subframe according to the RTK subframe structure.

In some embodiments, when the first UAV searches for the RTK subframe from the subframes sent by the second UAV at S601, the first UAV periodically performs the search according to a pre-set condition. Moreover, the first UAV may also synchronize with the control console controlling the first UAV by searching the pilot signal corresponding to the control console controlling the first UAV.

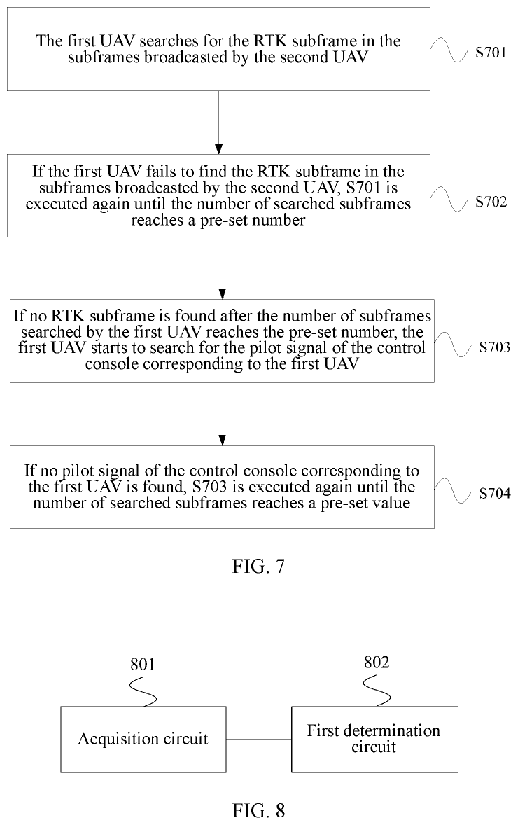

FIG. 7 is a flowchart of a method for processing out-of-synchronization of a UAV according to another example embodiment of the present disclosure. As shown in FIG. 7, S601 includes the following.

At S701, the first UAV searches for the RTK subframe in the subframes broadcasted by the second UAV.

At S702, if the first UAV fails to find the RTK subframe in the subframes broadcasted by the second UAV, S701 is executed again until the number of searched subframes reach a pre-set number.

When the first UAV finds the RTK subframe at a certain iteration, the first UAV obtains the base RTK observation value and the coordinate information of the observation site by following the previously described method. Further, the first UAV determines the high precision UAV positioning information based on the obtained information and determines the return route or flight route based on the high precision UAV positioning information.

The pre-set number of times for periodically searching the RTK subframe by the first UAV is greater than Tin the equation (1), so as to ensure that at least one RTK subframe sent by the second UAV appears within a searching time of the first UAV.

At S703, if no RTK subframe is found after the number of subframes searched by the first UAV reaches the pre-set number, the first UAV starts to search for the pilot signal of the control console corresponding to the first UAV.

At S704, if the first UAV does not find the pilot signal of the control console,

S703 is executed again until the number of searched subframes reaches a pre-set value.

When the first UAV finds the pilot signal of the control console controlling the first UAV at a certain iteration, the first UAV synchronizes with the control console controlling the first UAV according to the pilot signal. Further, the first UAV obtains control information from the control console controlling the first UAV to adjust the attitude/operating position to return the first UAV to a normal state.

When no pilot signal is found after the number of subframes searched by the first UAV reaches the pre-set value, S701 is executed again.

In some embodiments, after S302 is executed, when the UAV determines the return route based on the positioning information of the base station, the procedure includes the following.

Based on the positioning information and flight route information of the UAVs in the UAV system other than the first UAV, the first UAV determines the return route of the first UAV, such that the return route of the first UAV does not intersect with flight routes of other UAVs. More specifically, it is ensured that the return route of the first UAV does not overlap with any of the flight routes of the other UAVs. In some embodiments, it is ensured that when the first UAV passes by the flight route of a certain UAV when flying in the return route, the first UAV does not collide with the UAV in the flight route.

In some embodiments, the first UAV obtains in advance the flight route information of the other UAVs.

In some embodiments, after the first UAV establishes a communication connection with the control console, the first UAV receives operation route information of at least one third UAV sent by the control console. The third UAV is any UAV communicatively connected to the control console other than the first UAV. Specifically, each UAV in the UAV system plans in advance the flight route and broadcasts the planned flight route to all control consoles. Thus, after the first UAV establishes the communication connection with the control console, the control console sends the obtained operation routes of other UAVs to the first UAV.

In some embodiments, the first UAV receives the operation route information periodically broadcasted by the UAVs in the UAV system other than the first UAV and forwarded by the control console.

Specifically, each UAV in the UAV system periodically broadcasts its own operation route. After the first UAV establishes the connection with the control console, if the control console receives the operation route broadcasted by a certain UAV and determines that the operation route of the corresponding UAV has changed, the control console send the new operation route of the corresponding UAV to the first UAV. When the first UAV needs to determine the return route or the flight route, the first UAV makes the decision based on the new operation route, thereby preventing the first UAV from colliding with the other UAVs.

FIG. 8 is a structural block diagram of a first UAV according to an example embodiment of the present disclosure. The first UAV is one of the UAVs in the UAV system. The UAV system includes the base station and at least two UAVs. As shown in FIG. 8, the first UAV includes an acquisition circuit 801 and a first determination circuit 802.

The acquisition circuit 801 is configured to obtain the positioning information of the base station sent by the second UAV after the first UAV confirms that the first UAV is out of synchronization. The second UAV is any one of the UAVs in the UAV system other than the first UAV. The positioning information of the base station is broadcasted by the second UAV.

The first determination circuit 802 is configured to determine the positioning information of the first UAV based on the positioning information of the base station.

The first UAV implements the foregoing method embodiments. The operation principle and the technical effect are similar and will not be repeated herein.

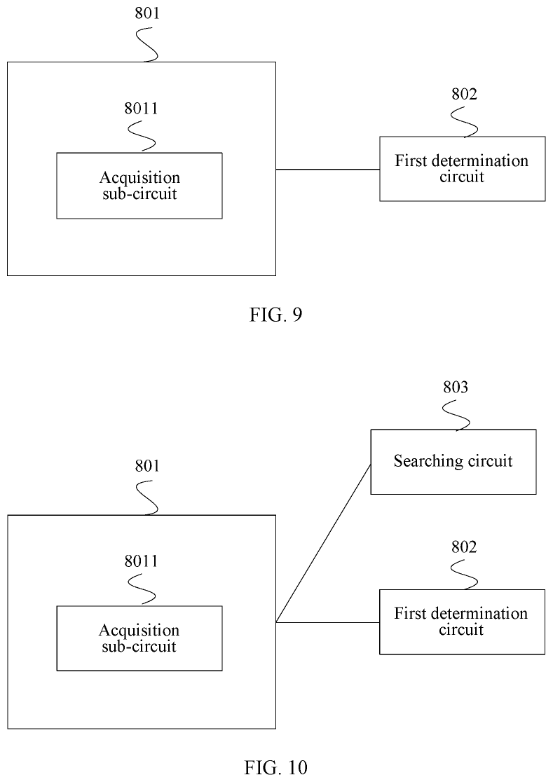

FIG. 9 is a structural block diagram of a first UAV according to another example embodiment of the present disclosure. As shown in FIG. 9, the positioning information of the base station includes the base RTK observation value and the coordinate information of the observation site. The acquisition circuit 801 includes an acquisition sub-circuit 8011 configured to obtain the base RTK observation value and the coordinate information from the RTK subframe sent by the second UAV after the first UAV confirms that the first UAV is out of synchronization.

In some embodiments, the RTK subframe includes a pilot signal and the RTK observation value and the coordinate information of the observation site.

In some embodiments, the second UAV periodically sends the RTK subframe at a pre-set position. The pre-set position is determined by the position of the second UAV in the UAV system.

In some embodiments, the acquisition sub-circuit 8011 is configured to search for the RTK subframe in the subframes broadcasted by the second UAV and to decode the RTK observation value and the coordinate information of the observation site from the RTK subframe obtained by searching.

In some embodiments, the acquisition sub-circuit is further configured for the first UAV to search for the RTK subframe in the subframes broadcasted by the second UAV. When the first UAV does not find the RTK subframe in the subframes broadcasted by the second UAV, the first UAV continues to search for the RTK subframe in the subframes broadcasted by the second UAV until the number of subframes searched by the first UAV reach a pre-set number.

FIG. 10 is a structural block diagram of a first UAV according to another example embodiment of the present disclosure. As shown in FIG. 10, the first UAV further includes a searching circuit 803 configured to search for a pilot signal of the control console corresponding to the first UAV when no RTK subframe is found after the number of subframes searched by the first UAV reaches the pre-set number.

FIG. 11 is a structural block diagram of a first UAV according to another example embodiment of the present disclosure. As shown in FIG. 11, the first UAV further includes a second determination circuit 804 configured to determine a return route of the first UAV based on positioning information.

In some embodiments, the second determination circuit 804 is further configured to determine the return route of the first UAV based on positioning information and operation route information for the UAVs in the UAV system other than the first UAV, such that the return route of the first UAV does not intersect with the operation routes of the UAVs in the UAV system other than the first UAV. More specifically, it is ensured that the return route of the first UAV does not overlap with any of the flight routes of the other UAVs. In some embodiments, it is ensured that when the first UAV passes by the flight route of a certain UAV when flying in the return route, the first UAV does not collide with the UAV in the flight route.

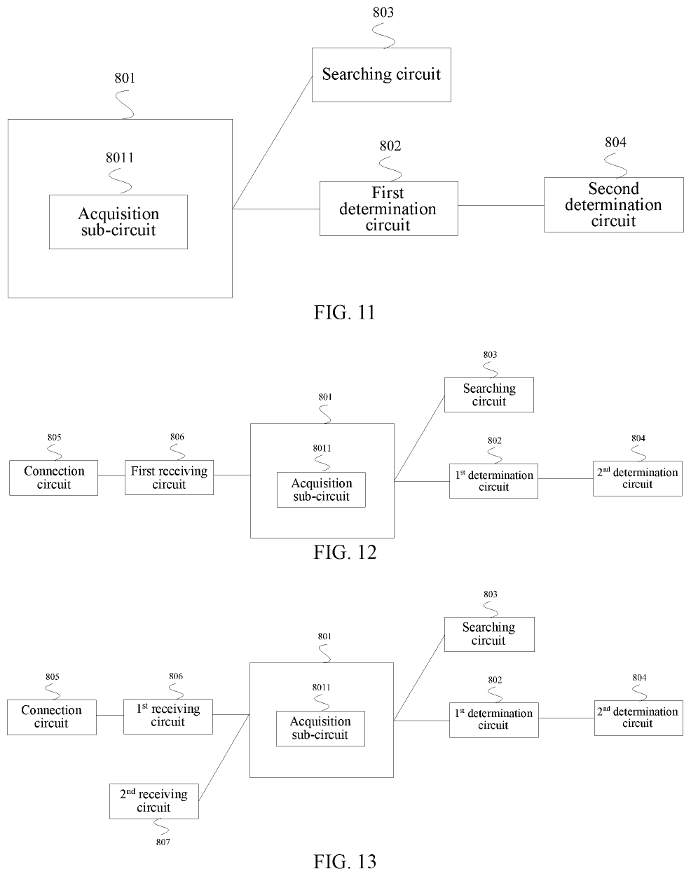

FIG. 12 is a structural block diagram of a first UAV according to another example embodiment of the present disclosure. As shown in FIG. 12, the UAV system further includes at least one control console and the first UAV further includes a connection circuit 805 configured to establish a communication connection with the control console controlling the first UAV and a first receiving circuit 806 configured to receive the operation route information of at least one third UAV sent by the control console. The third UAVs are UAVs communicatively connected to the control console other than the first UAV.

FIG. 13 is a structural block diagram of a first UAV according to another example embodiment of the present disclosure. As shown in FIG. 13, the first UAV further includes a second receiving circuit 807 configured to receive the operation route information periodically broadcasted by the UAVs in the UAV system other than the first UAV and forwarded by the control console.

Those skilled in the art may understand that all or some processes of the foregoing method embodiments may be implemented by program instructions instructing related hardware. The program may be stored in a computer-readable storage medium that together with a processor form a device for processing out-of-synchronization, which can be implemented in, e.g., the first UAV. When being executed, the program causes the processor to execute part or all of a method consistent with the disclosure, such as one of the example methods described above. The storage medium includes any medium for storing the program instructions, such as a read-only memory (ROM), a random-access memory (RAM), a magnetic disk, or an optical disk.

Various embodiments of the present disclosure are merely used to illustrate the technical solution of the present disclosure, but the scope of the present disclosure is not limited thereto. Although the present disclosure has been described in detail with reference to the foregoing embodiments, those skilled in the art should understand that the technical solution described in the foregoing embodiments can still be modified or some or all technical features can be equivalently replaced. Without departing from the spirit and principles of the present disclosure, any modifications, equivalent substitutions, and improvements, etc., shall fall within the scope of the present disclosure. Thus, the scope of invention should be determined by the appended claims.

What is claimed is:

1. An out-of-synchronization processing method comprising:
determining, by a first unmanned aerial vehicle (UAV), whether the first UAV is out of synchronization;
obtaining, by the first UAV in response to confirming that the first UAV is out of synchronization, base positioning information of a base station broadcasted by a second UAV; and
determining, by the first UAV based on the base positioning information, UAV positioning information of the first UAV;
wherein the first UAV and the second UAV belong to a UAV system including the base station and at least two UAVs.

2. The method of claim 1, wherein:
the base positioning information includes a base real time kinetics (RTK) observation value of the base station and coordinate information of an observation site; and
obtaining the base positioning information includes obtaining the base RTK observation value and the coordinate information of the observation site from an RTK subframe sent by the second UAV.

3. The method of claim 2, wherein the RTK subframe includes a pilot signal, the base RTK observation value, and the coordinate information of the observation site.

4. The method of claim 3, wherein the RTK subframe is sent by the second UAV periodically at a pre-set position determined by a position of the second UAV in a UAV system including the first UAV and the second UAV.

5. The method of claim 2, wherein obtaining the base RTK observation value and the coordinate information of the observation site from the RTK subframe sent by the second UAV includes:
searching, by the first UAV, for the RTK subframe in subframes broadcasted by the second UAV; and
decoding, by the first UAV, the base RTK observation value and the coordinate information of the observation site from the RTK subframe obtained by searching.

6. The method of claim 5, wherein searching for the RTK subframe in the subframes includes, in response to not finding the RTK subframe, continuing to search in the subframes broadcasted by the second UAV until a number of searched subframes reaches a pre-set number.

7. The method of claim 6, further comprising:
searching, by the first UAV, a pilot signal of a control console corresponding to the first UAV in response to no RTK subframe being found after the number of searched subframes reaches the pre-set number.

8. The method of claim 1, further comprising:
determining, by the first UAV, a return route of the first UAV based on the UAV positioning information.

9. The method of claim 8, wherein determining the return route of the first UAV includes determining the return route of the first UAV based on the UAV positioning information and information about operation routes of other UAVs in the UAV system other than the first UAV, such that the return route of the first UAV does not intersect with the operation routes of the other UAVs.

10. The method of claim 1, further comprising, after confirming that the first UAV is out of synchronization and before obtaining the base positioning information:
establishing, by the first UAV, a communication connection with a control console in the UAV system; and
receiving operation route information of a third UAV sent by the control console, the third UAV being communicatively connected to the control console.

11. The method of claim 1, further comprising, after confirming that the first UAV is out of synchronization and before obtaining the base positioning information:
receiving, by the first UAV, operation route information of another UAV in the UAV system sent by a control console in the UAV system, the operation route information being periodically broadcasted by the another UAV.

12. A first unmanned aerial vehicle (UAV) comprising:
a processor; and
a computer-readable storage medium storing instructions that, when executed by the processor, cause the processor to:
determine whether the first UAV is out of synchronization;
obtain, in response to confirming that the first UAV is out of synchronization, base positioning information of a base station broadcasted by a second UAV; and
determine, based on the base positioning information, UAV positioning information of the first UAV;
wherein the first UAV and the second UAV belong to a UAV system including the base station and at least two UAVs.

13. The first UAV of claim 12, wherein the base positioning information includes a base real time kinetics (RTK) observation value of the base station and coordinate information of an observation site.

14. The first UAV of claim 13, wherein the RTK subframe includes a pilot signal, the base RTK observation value, and the coordinate information of the observation site.

15. The first UAV of claim 14, wherein the RTK subframe is sent by the second UAV periodically at a pre-set position determined by a position of the second UAV in a UAV system including the first UAV and the second UAV.

16. The first UAV of claim 13, wherein the instructions further cause the processor to:
search for the RTK subframe in subframes broadcasted by the second UAV; and
decode the base RTK observation value and the coordinate information of the observation site from the RTK subframe obtained by searching.

17. The first UAV of claim 16, wherein the instructions further cause the processor to, in response to not finding the RTK subframe, continue to search in the subframes broadcasted by the second UAV until a number of searched subframes reaches a pre-set number.

18. The first UAV of claim 17, wherein the instructions further cause the processor to search a pilot signal of a control console corresponding to the first UAV in response to no RTK subframe being found after the number of searched subframes reaches the pre-set number.

19. An unmanned aerial vehicle (UAV) system comprising:
a base station;
a first UAV; and
a second UAV;
wherein the first UAV is configured to:
determine whether the first UAV is out of synchronization;
obtain, in response to confirming that the first UAV is out of synchronization, base positioning information of the base station broadcasted by the second UAV; and
determine, based on the base positioning information, UAV positioning information of the first UAV.

20. The UAV system of claim 19, further comprising:
a control console.
